(19) United States
(12) Patent Application Publication
(10) Pub. No.: US 2012/0082394 A1
(43) Pub. Date: Apr. 5, 2012

(54) IMAGE PROCESSING APPARATUS AND IMAGE PROCESSING METHOD

(75) Inventors: Wei-Chi Su, Tainan City (TW); Chih-Chia Kuo, Hsinchu County (TW)

(73) Assignee: NOVATEK MICROELECTRONICS CORP., Hsinchu (TW)

(21) Appl. No.: 13/176,755

(22) Filed: Jul. 6, 2011

(30) Foreign Application Priority Data
Oct. 4, 2010 (TW) 99133754

(51) Int. Cl. G06K 9/36

(52) U.S. Cl. 382/236

(57) ABSTRACT

An image processing apparatus including an image detecting unit, an image interpolating unit and an image blending unit is provided. The image detecting unit detects a pixel difference value of an image frame and a previous image frame or a next image frame thereof and outputs a weight value according to the pixel difference value. The image interpolating unit interpolates a pixel value of the image frame in an intra-field interpolation method and an inter-field interpolation method. The image blending unit blends the pixel value interpolated in the intra-field interpolation method and the pixel value interpolated in the inter-field interpolation method to restore the image frame according to the weight value. An image processing method is also provided.

### CROSS-REFERENCE TO RELATED APPLICATION

This application claims the priority benefit of Taiwan application serial no. 99133754, filed Oct. 4, 2010. The entirety of the above-mentioned patent application is hereby incorporated by reference herein and made a part of this specification.

### BACKGROUND OF THE INVENTION

1. Field of the Invention

The invention relates generally to a multimedia processing apparatus and a multimedia processing method. More particularly, the invention relates to an image processing apparatus and an image processing method.

2. Description of Related Art

As computing power rapidly advances in the recent years, digital mediums have become people's preferred tools for the expression of creativity and imagination. In particular, developments in digital image processing applications and related imaging products have allowed people to digitally capture and store the minute details of life.

However, as digital images require a great volume of data, many multimedia storage or compression standards adopt the YUV420 color format in order to reduce the data volume of the digital images. When playing back the digital images, the image output device transforms the digital image data from the YUV420 color format to the YUV422 color format. In the YUV420 color format, vertical color information of the digital images is half of the original before down-sampling. Additionally, when the interlaced mode is used to generate digital images, a color line drop issue becomes more severe, especially on the vertical direction during high frequency color changes. The restored images exhibit definite color sawtooth patterns and may even exhibit the combing phenomenon.

Moreover, when transforming the digital image data from the YUV420 color format to the YUV422 color format, the image output device typically employs a high grayscale filter. However, the high grayscale vertical filter requires a large volume of data storage, which seriously increases costs. On the other hand, if a low grayscale filter is used, then the digital images are comparatively blurry.

The YUV420 color format transformation to the YUV422 color format under the MPEG (Motion Picture Experts Group) or other compression standards can be executed under the interlaced mode or the progressive mode. When decompression is performed, a front-end compression circuit flags a method employed during compression for a back-end image output device to perform decompression. According to the flag data, the image output device can reduce the visual side effects produced by the YUV420 color format.

However, a portion of the front-end compression circuit may have inaccurately set the flag data. Consequently, when the back-end image output device performs decompression, an inferior decompression method is used to restore the YUV420 color format to the YUV422 color format, thereby producing even more severe visual side effects.

### SUMMARY OF THE INVENTION

An aspect of the invention provides an image processing apparatus employing a motion detection method to determine a relationship between a target image for restoration and a previous image and a next image thereof, so as to restore a color format and to effectively reduce visual side effects produced during compression.

Another aspect of the invention provides an image processing method employing a motion detection method to determine a relationship between a target image for restoration and a previous image and a next image thereof, so as to restore a color format and to effectively reduce visual side effects produced during compression.

An aspect of the invention provides an image processing apparatus, including an image detecting unit, an image interpolating unit, and an image blending unit. The image detecting unit detects a pixel difference value of an image frame and a previous image frame or a next image frame thereof and outputs a weight value according to the pixel difference value. The image interpolating unit interpolates a pixel value of the image frame in an inter-field interpolation method and an inter-field interpolation method. The image blending unit blends the pixel value interpolated in the intra-field interpolation method and the pixel value interpolated in the inter-field interpolation method according to the weight value, so as to restore the image frame.

According to an embodiment of the invention, the image interpolation unit includes an intra-field interpolation unit and an intra-field interpolation unit. The intra-field interpolation unit interpolates the pixel value of the image frame in the intra-field interpolation method. The inter-field interpolation unit interpolates the pixel value of the image frame in the inter-field interpolation method.

According to an embodiment of the invention, when the intra-field interpolation unit interpolates the pixel value of the image frame in the intra-field interpolation method, the pixel values of the adjacent pixel points near a target pixel point of the image frame are referenced to interpolate the pixel value of the target pixel point.

According to an embodiment of the invention, when the inter-field interpolation unit interpolates the pixel value of the image frame in the inter-field interpolation method, the pixel value of the pixel point corresponding to a target pixel point on an odd field or an even field of the previous image frame, or the pixel value of the pixel point corresponding to the target pixel point on an odd field or an even field of the next image frame is referenced to interpolate the pixel value of the target pixel point.

According to an embodiment of the invention, the image frame includes an odd field and an even field. The image detecting unit respectively compares the odd field and the even field of the image frame with an odd field and an even field of the previous image frame, or with an odd field and an even field of the next image frame, so as to obtain the pixel difference value.

According to an embodiment of the invention, the pixel value of the image frame includes a grayscale value, a chroma value, or a luminance value.

Another aspect of the invention provides an image processing method adapted for an image processing apparatus. The image processing method includes the following steps. An pixel difference value of an image frame and a previous image frame or a next image frame thereof is detected. A weight value is outputted according to the pixel difference value. A pixel value of the image frame is interpolated in an intra-field interpolation method and an inter-field interpolation method. The pixel value interpolated in the intra-field interpolation method and the pixel value interpolated in the inter-field interpolation method are blended according to the weight value, so as to restore the image frame.

According to an embodiment of the invention, in the step of interpolating the pixel value of the image frame in the intra-field interpolation method and the inter-field interpolation method, when the pixel value of the image frame is interpolated in the intra-field interpolation method, the pixel values of the adjacent pixel points near a target pixel point of the image frame are referenced to interpolate the pixel value of the target pixel point.

According to an embodiment of the invention, in the step of interpolating the pixel value of the image frame in the intra-field interpolation method and the inter-field interpolation method, when the pixel value of the image frame is interpolated in the inter-field interpolation method, the pixel value of the pixel point corresponding to the target pixel point on an odd field or an even field of the previous image frame, or the pixel value of the pixel point corresponding to the target pixel point on an odd field or an even field of the next image frame is referenced to interpolate the pixel value of the target pixel point.

According to an embodiment of the invention, the image frame includes an odd field and an even field. Moreover, in the step of detecting the pixel difference value of the image frame and the previous image frame or the next image frame thereof, the odd field and the even field of the image frame are respectively compared with an odd field and an even field of the previous image frame, or with an odd field and an even field of the next image frame, so as to obtain the pixel difference value.

In summary, according to embodiments of the invention, the image processing apparatus and the image processing method thereof employ the motion detection method to determine the pixel difference value of the target image for restoration and the previous image or the next image, and thereby determining the weight value when restoring the target image frame.

It is to be understood that both the foregoing general descriptions and the following detailed embodiments are exemplary and are, together with the accompanying drawings, intended to provide further explanation of technical features and advantages of the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram of an image processing apparatus according to an embodiment of the invention.

FIG. 2 is a schematic view of a motion detection method according to an embodiment of the invention.

FIG. 3 is a schematic graph illustrating a correlation between a pixel difference value and a weight value.

FIG. 4 is a schematic view illustrating pixels in the intra-field interpolation method according to an embodiment of the invention.

FIG. 5 is a flowchart illustrating the steps of an image processing method according to an embodiment of the invention.

### DESCRIPTION OF EMBODIMENTS

According to exemplary embodiments of the invention, when an image processing apparatus restores a color format of an image frame from YUV420 to YUV422, a grayscale value and a color information are referenced. At the same time, under the interlaced mode, the image processing apparatus considers an amount of a pixel motion so as to find an optimal reference point in the time domain. Thereafter, the image processing apparatus uses the reference point and a related weight value to interpolate a high color vertical resolution, while effectively reducing the visual side effects produced during compression.

In the exemplary embodiments described hereafter, a chroma value of a target pixel point is interpolated, although the invention should not be construed as limited thereto.

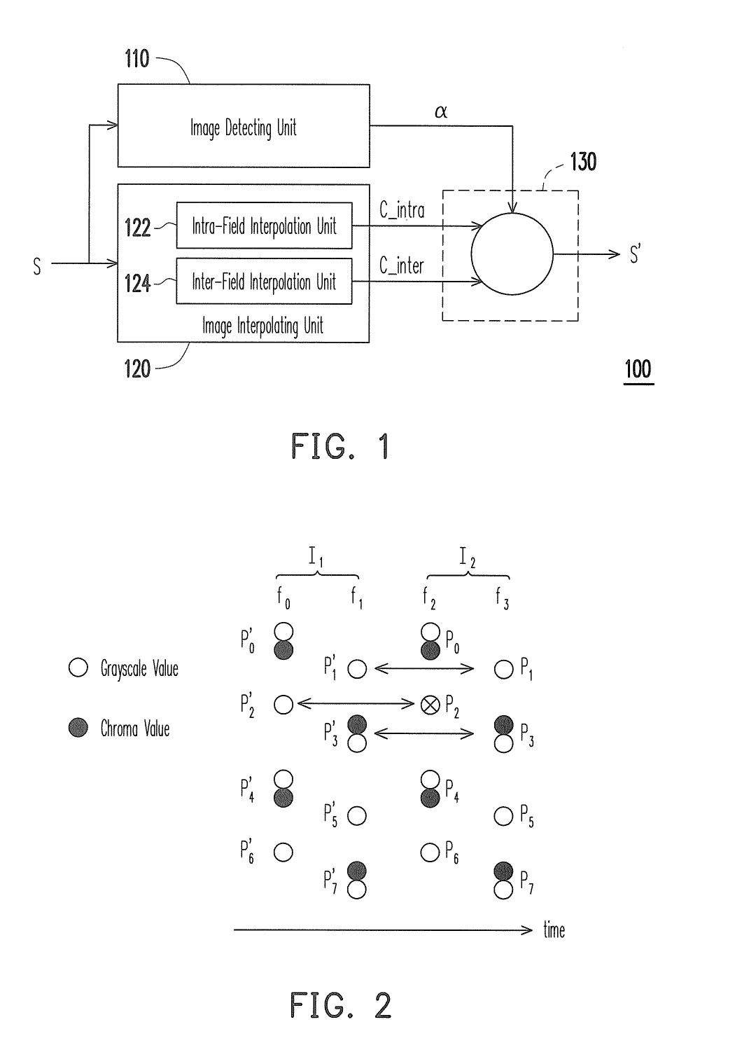

FIG. 1 is a schematic block diagram of an image processing apparatus according to an embodiment of the invention. Referring to FIG. 1, in the present embodiment, an image processing apparatus 100 includes an image detecting unit 110, an image interpolating unit 120, and an image blending unit 130. The image interpolating unit 120 includes an intra-field interpolation unit 122 and an inter-field interpolation unit 124.

In the present embodiment, after the image detecting unit 110 receives an image signal S, a pixel difference value of a target image frame (e.g., the current image frame) and a previous image frame or a next image frame thereof are detected. Moreover, a weight value a is outputted to the image blending unit 130 according to the pixel difference value.

On the other hand, the image interpolating unit 120 also receives the image signal S in order to interpolate the target image frame. In the present embodiment, the intra-field interpolation unit 122 interpolates a pixel value of the target image frame in an intra-field interpolation method and outputs a pixel value C_intra to the image blending unit 130 after interpolation. At the same time, the inter-field interpolation unit 124 interpolates a pixel value of the target image frame in an inter-field interpolation method and outputs a pixel value C_inter to the image blending unit 130 after interpolation.

Thereafter, the image blending unit 130 blends the pixel values C_intra and C_inter interpolated by the image interpolating unit 120 according to the weight value α determined by the image detecting unit 110, so as to restore the image frame and output an image signal S′. The pixel values C_intra and C_inter interpolated by the image interpolating unit 120 are, for example, chroma values of the pixel points in the target image frame.

Therefore, the image processing apparatus 100 according to the present embodiment does not rely on a flag provided by a front-end compression circuit to perform image restoration. Even if the front-end compression circuit fails to accurately set the flag data, the image processing apparatus 100 can still interpolate a high color vertical resolution, thereby effectively enhancing image output quality.

More specifically, the image detecting unit 110 is, for example, a motion image detector using a motion detection method to determine the pixel difference value of the target image frame and the previous image frame or the next image frame thereof, and further to determine the weight value α referenced by the image blending unit 130 during the restoration of the image frame.

FIG. 2 is a schematic view of a motion detection method according to an embodiment of the invention. Referring to FIGS. 1 and 2, in the present embodiment, the image compression is performed, for example, in an interlaced mode. Therefore, the image frames I₁ and I₂ received by the image detecting unit 110 respectively includes, for example, even fields f₀ and f₂ and odd fields f₁ and f₃. Moreover, the symbol ◯ represents the grayscale value of the pixel point, the symbol represents the chroma value of the pixel point, and the symbol [symbol] represents the grayscale value of the target pixel point for interpolation in the present embodiment.

In the interlaced mode, the even and odd fields respectively includes only the data from every other column in the original image frame. The even fields display the image signal of the even scan lines, whereas the odd fields display the image signal of the odd scan lines, and the two image signals are alternately displayed. Since the even and odd fields respectively includes only the data from every other row in the original image frame, therefore in a same field, the color information on the vertical direction is half of the original image frame. Moreover, adjacent pixel points commonly reference a chroma value. Therefore, when restoring the image frame, the image processing apparatus 100 needs to interpolate the chroma values of the pixel points which lack the chroma values.

For example, in the even field f₂, the pixel points P₀ and P₂ commonly reference the chroma value of the pixel point P₀. Likewise, the pixel points P₄ and P₆ commonly reference the chroma value of the pixel point P₄, and so on. Hence, the image interpolating unit 120 needs to interpolate the chroma values of the pixel points P₂ and P₆ in order to restore the image frame.

In FIG. 2, when the interpolation target of the image interpolating unit 120 is the image frame I₂, then with respect to time, the image frame I₁ is the previous image frame of the image frame I₂. Conversely, when the interpolation target of the image interpolating unit 120 is the image frame I₁, then with respect to time, the image frame I₂ is the next image frame of the image frame I₁. In the present embodiment, the interpolation target of the image interpolating unit 120 is, for example, the pixel point P₂ (e.g., indicated by the symbol [symbol] in FIG. 2) of the image frame I₂. Therefore, the image frame I₁ is the previous image frame of the image frame I₂.

When objects on the previous image frame I₁ move, the pixel values of the corresponding pixel points on the following image frame I₂ also produce a pronounced changing difference value. For example, in the odd field f₁, when the object corresponding to the location of the pixel point P₃′ moves, a pronounced changing pixel difference value is exhibited by the grayscale value and the chroma value of the pixel point P₃ on the odd field f₃ compared with the grayscale value and chroma value of the pixel point P₃′ (e.g., the grayscale or chroma difference values between the pixel points P₃ and P₃′). Similarly, in the even field f₀, when the object corresponding to the location of the pixel point P₄′ moves, a pixel difference value is exhibited by the grayscale value and the chroma value of the pixel point P₄ on the even field f₂ compared with the grayscale value and chroma value of the pixel point P₄′ (e.g., the grayscale or chroma difference values between the pixel points P₄ and P₄′).

Accordingly, in the present embodiment, when objects on the previous image frame I₁ move, the image detecting unit 110 exemplarily compares the pixel values of the pixel points P₃′ and P₃ or P₄′ and P₄, so as to obtain the pixel difference value. In the present embodiment, the image detecting unit 110 compares the previous image frame and the target image frame, for example, although the invention is not limited thereto. In other embodiments of the invention, the image detecting unit 110 may also compare the next image frame and the target image frame, or simultaneously compare the previous image frame with the next image frame and the target image frame, so as to obtain the pixel difference value.

Therefore, the image detecting unit 110 employs the afore-described motion detection method to determine whether objects on the image frame have moved, so as to determine the pixel difference value of the target image frame and the previous image frame or the next image frame thereof, and further to determine the weight value α referenced by the image blending unit 130 during restoration of the image frame.

In other words, in order to obtain the pixel difference value, the image detecting unit respectively compares the odd fields and the even fields of the image frame with the odd fields and the even fields of the previous image frame, or with the odd fields and the even fields of the next image frame. After obtaining the pixel difference value, the image detecting unit produces the weight value in accordance with the pixel difference value and outputs the weight value to the image blending unit.

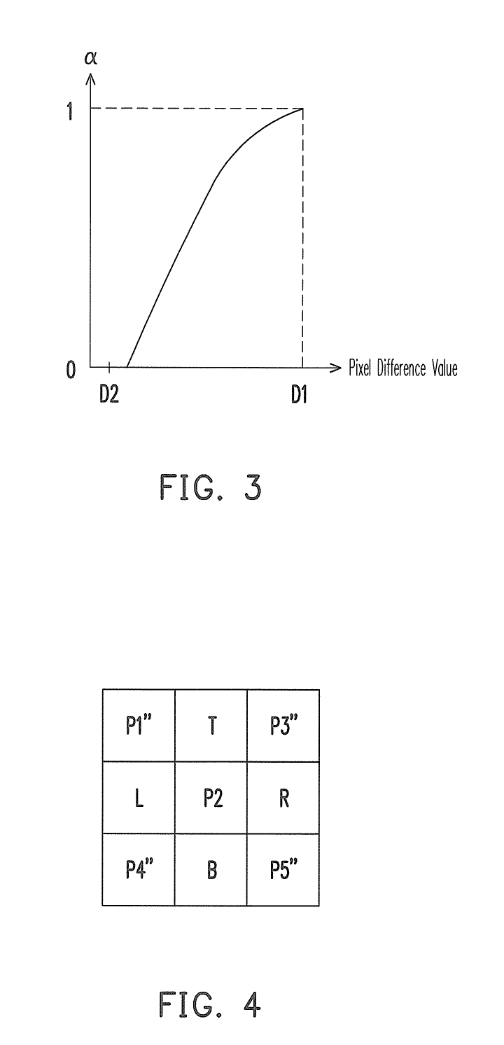

FIG. 3 is a schematic graph illustrating a correlation between the pixel difference value and the weight value. Referring to FIGS. 1 to 3, in the present embodiment, after the image detecting unit 110 determines the pixel difference value by the afore-described motion detection method, the weight value α may be produced in accordance with the correlative graph in FIG. 3. Thereafter, the image blending unit 130 uses, for example, a proportional relationship of C_intra×α+C_inter×(1−α) to restore the image frame.

For example, in motion images, the objects on the image frames typically exhibit pronounced changes, therefore a pixel difference value D1 detected by the image detecting unit 110 is comparatively large. According to FIG. 3, the pixel difference value D1 corresponds to, for example, α=1. Therefore, when the image blending unit 130 restores the image frame, a proportional relationship of C_intra×1+C_inter×0, for example, is used to restore the image frame. Hence, at this time the image blending unit 130 restores the image frame in accordance with the interpolation result of the intra-field interpolation unit 122.

Moreover, in static images for example, the objects on the image frames typically do not exhibit major changes, therefore a pixel difference value D2 detected by the image detecting unit 110 is comparatively small. According to FIG. 3, the pixel difference value D2 corresponds to, for example, α=0. Therefore, when the image blending unit 130 restores the image frame, a proportional relationship of C_intra×0+C_inter×1, for example, is used to restore the image frame. Hence, at this time the image blending unit 130 restores the image frame in accordance with the interpolation result of the inter-field interpolation unit 124.

Therefore, according to a degree of variation in the image frame, the corresponding a in FIG. 3 referenced by the image detecting unit 110 also varies in a corresponding degree. Hence, according to the embodiments of the invention, in order to restore the image frame, the image processing apparatus 100 may suitably adjust the proportional relationship between the pixel value C_intra interpolated in the intra-field interpolation method and the pixel value C_inter interpolated in the inter-field interpolation method according to the degree of variation in the image frame, without relying on a flag provided by the front-end compression circuit to perform image restoration. Therefore, even if the front-end compression circuit fails to accurately set the flag data, the image processing apparatus 100 can still interpolate a high color vertical resolution, thereby effectively enhancing image output quality.

Taking the chroma values interpolated by the inter-field interpolation unit 124 for example, the chroma value of the target pixel point is interpolated in the inter-field interpolation method. Moreover, according to the present embodiment, the inter-field interpolation method employs the inter-field interpolation unit 124 to use the chroma values of a pixel at a same location on a previous image frame or a next image frame, so as to interpolate the chroma value of the target pixel point.

In other words, when the inter-field interpolation unit 124 interpolates the pixel value of the image frame in the inter-field interpolation method, the pixel value of the pixel point corresponding to the target pixel point on the odd field or the even field of the previous image frame, or the pixel value of the pixel point corresponding to the target pixel point on the odd field or the even field of the next image frame is referenced to interpolate the pixel value of the target pixel point.

Taking the chroma values interpolated by the intra-field interpolation unit 122 for example, the chroma value of the target pixel point is interpolated in the intra-field interpolation method. When the intra-field interpolation unit 122 interpolates the pixel value of the image frame in the intra-field interpolation method, the pixel values of the adjacent pixel points near the target pixel point of the image frame are referenced to interpolate the pixel value of the target pixel point.

More specifically, FIG. 4 is a schematic view illustrating pixels in the intra-field interpolation method according to an embodiment of the invention. Referring to FIGS. 1-4, FIG. 4 illustrates in the even field f₂ of the image frame I₂ the target pixel point P₂ for interpolation by the intra-field interpolation unit 122, as well as 8 adjacent pixel points T, B, L, R, P₁″, P₃″, P₄″, and P₅″ nearby.

In FIG. 4, the first row having the pixel points P₁″, T, P₃″ and the third row having the pixel points P₄″, B, P₅″ include grayscale values and chroma values thereof. On the other hand, the second row having the pixel points L, P₂, and R include only the grayscale values thereof. Therefore, in the present embodiment, the intra-field interpolation unit 122 interpolates the chroma value of the target pixel point P₂ in the intra-field interpolation method detailed hereafter.

Firstly, before interpolating the chroma value of the target pixel point P₂, the intra-field interpolation unit 122 first confirms whether a grayscale difference value between the grayscale value of the pixel point P₂ and the grayscale values of the 8 adjacent pixel points is larger than a grayscale threshold value. For example, the intra-field interpolation unit 122 calculates a difference value between the grayscale value of the pixel point P₂ and an average value of the grayscale values of the 8 adjacent pixel points, compares with the grayscale threshold value, then takes the larger of the two as an effective grayscale threshold value.

The afore-described judging method may be exemplarily depicted by a programmable code as follows:

valid_th=max((y_{P2}−(y_{P1″}+y_{T}+y_{P3″}+y_{L}+y_{R}+y_{P4″}+p_{B}+y_{P5″})/8),coring_th)

where valid_th is the effective grayscale threshold value, coring_th is the grayscale threshold value, and y_{P2}, y_{P1″}, y_{T}, y_{P3″}, y_{L}, y_{R}, y_{P4″}, y_{B}, y_{P5} are the grayscale values of the pixel point P₂ and the 8 adjacent pixel points, respectively.

Thereafter, the intra-field interpolation unit 122 determines a weight value ω of the pixel point T for interpolating the chroma value of the target pixel point P₂ according to a relationship between chroma values of the pixel points T, B, P₁″, P₃″, P₄″, and P₅″.

For example, when the chroma value of the pixel point P₁″ is closer to the chroma value of the pixel point T, then the pixel point T may receive two votes. Conversely, when the chroma value of the pixel point P₁″ is closer to the chroma value of the pixel point B, then the pixel point B may receive two votes. When the chroma value of the pixel point P₁″ is close to the chroma values of the pixel points T and B (e.g., with a difference less than the effective grayscale threshold value valid_th), then the pixel points T and B may each receive one vote. Similarly, the votes received by the pixel points T and B through the pixel points P₃″, P₄″, and P₅″ may also be determined by the afore-described method.

For example, assuming the chroma values of the pixel points T, B, P₁″, P₃″, P₄″, and P₅″ are respectively 100, 200, 120, 120, 150, and 150, then the votes received by the pixel point T through the pixel points P₁″, P₃″, P₄″, and P₅″ are respectively 2, 2, 1, and 1 (i.e., 6 total votes), for example. Moreover, the votes received by the pixel point B through the pixel points P₁″, P₃″, P₄″, and P₅″ are respectively 0, 0, 1, and 1 (i.e., 2 total votes), for example.

Therefore, the intra-field interpolation unit 122 determines the weight value ω of the pixel point T for interpolating the chroma value of the target pixel point P₂ according to a ratio of the total votes of the pixel points T and B.

The afore-described judging method may be exemplarily depicted by a programmable code as follows:
For (P″=P₁″, P₃″, P₄″, P₅″)
if (choma_{P″}, closer to choma_{T} than chroma_{B} by more than valid_th)
   vote_{T}+=2
else if (choma_{P″} closer to choma_{B} than chroma_{T} by more than valid_th)
   vote_{B}+=2
else {vote_{T}+=1, vote_{B}+=1}

where choma_{P″} represents the chroma value of each of the pixel points (P₁″, P₃″, P₄″, P₅″), choma_{T} and chroma_{B} are the respective chroma values of the pixel points T and B, and vote_{T} and vote_{B} are the votes received.

After determining the weight value w of the pixel point T, the intra-field interpolation unit 122 interpolates the chroma value of the target pixel point P₂ in accordance with the following formula:

x=ω×t+(1−ω)×b

where x, t, and b are the chroma values of the pixel points P₂, T, and B, respectively.

Therefore, in the present embodiment, the intra-field interpolation unit 122 interpolates the chroma value of the target pixel point P₂ in the intra-field interpolation method detailed above.

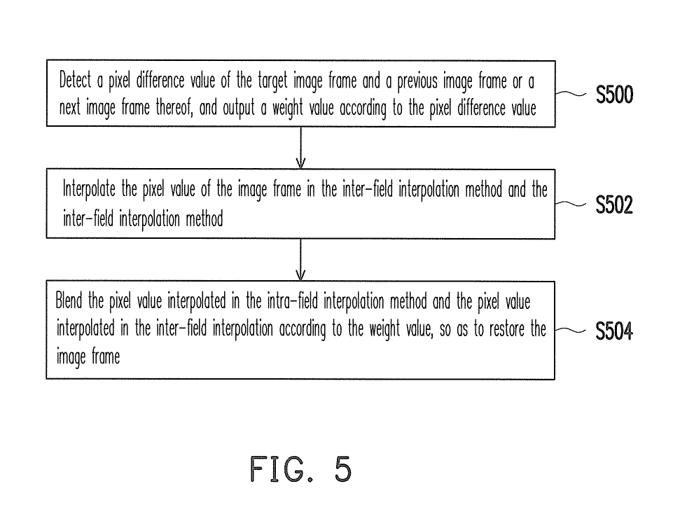

FIG. 5 is a flowchart illustrating the steps of an image processing method according to an embodiment of the invention. With reference to FIGS. 1 and 5, the image processing method of the present embodiment includes the following steps.

In a Step S500, by using the image detecting unit 110, a pixel difference value of the target image frame and a previous image frame or a next image frame thereof is detected. Moreover, a weight value is outputted according to the pixel difference value.

On the other hand, in a Step S502, by using the image interpolating unit 120, the pixel value of the image frame is interpolated in the intra-field interpolation method and the inter-field interpolation method.

Thereafter, in a Step S504, by using the image blending unit 130, the pixel value interpolated in the intra-field interpolation method and the pixel value interpolated in the inter-field interpolation method are blended according to the weight value, so as to restore the image frame.

It should be noted that, although in the present embodiment the Step S500 is depicted as being performed before the Step S502, the invention should not be construed as limited thereto. When interpolation is performed in practice, the Steps S500 and S502 may be concurrently executed.

Moreover, the image processing method described in the present embodiment of the invention is sufficiently taught, suggested, and embodied in the embodiments illustrated in FIGS. 1-4, and therefore no further description is provided herein.

In view of the foregoing, according to exemplary embodiments of the invention, the image processing apparatus and the image processing method thereof employ the motion detection method to determine the pixel difference value of the target image for restoration and the previous image or the next image, and thereby determining the weight value when restoring the target image frame. Therefore, the image processing apparatus according does not rely on the flag provided by the front-end compression circuit to perform image restoration. Moreover, even if the front-end compression circuit fails to accurately set the flag data, the image processing apparatus can still interpolate a high color vertical resolution, thereby effectively enhancing image output quality.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An image processing apparatus, comprising:
an image detecting unit detecting a pixel difference value of an image frame and a previous image frame or a next image frame thereof and outputting a weight value according to the pixel difference value;
an image interpolating unit interpolating a pixel value of the image frame in an intra-field interpolation method and an inter-field interpolation method; and
an image blending unit blending the pixel value interpolated in the intra-field interpolation method and the pixel value interpolated in the inter-field interpolation method according to the weight value, so as to restore the image frame.

2. The image processing apparatus as claimed in claim 1, wherein the image interpolation unit comprises:
an intra-field interpolation unit interpolating the pixel value of the image frame in the intra-field interpolation method; and
an inter-field interpolation unit interpolating the pixel value of the image frame in the inter-field interpolation method.

3. The image processing apparatus as claimed in claim 2, wherein when the intra-field interpolation unit interpolates the pixel value of the image frame in the intra-field interpolation method, pixel values of adjacent pixel points near a target pixel point of the image frame are referenced to interpolate the pixel value of the target pixel point.

4. The image processing apparatus as claimed in claim 2, wherein when the inter-field interpolation unit interpolates the pixel value of the image frame in the inter-field interpolation method, a pixel value of a pixel point corresponding to a target pixel point on an odd field or an even field of the previous image frame, or a pixel value of a pixel point corresponding to the target pixel point on an odd field or an even field of the next image frame is referenced to interpolate the pixel value of the target pixel point.

5. The image processing apparatus as claimed in claim 1, wherein the image frame comprises an odd field and an even field, the image detecting unit respectively compares the odd field and the even field of the image frame with an odd field and an even field of the previous image frame, or with an odd field and an even field of the next image frame, so as to obtain the pixel difference value.

6. The image processing apparatus as claimed in claim 1, wherein the pixel value of the image frame comprises a grayscale value, a chroma value, or a luminance value.

7. An image processing method adapted for an image processing apparatus, the method comprising:
detecting an pixel difference value of an image frame and a previous image frame or a next image frame thereof;
outputting a weight value according to the pixel difference value;
interpolating a pixel value of the image frame in an intra-field interpolation method and an inter-field interpolation method; and
blending the pixel value interpolated in the intra-field interpolation method and the pixel value interpolated in the inter-field interpolation method according to the weight value, so as to restore the image frame.

8. The image processing method as claimed in claim 7, wherein in the step of interpolating the pixel value of the image frame in the intra-field interpolation method and the inter-field interpolation method, when the pixel value of the image frame is interpolated in the intra-field interpolation method, pixel values of adjacent pixel points near a target pixel point of the image frame are referenced to interpolate the pixel value of the target pixel point.

9. The image processing method as claimed in claim 7, wherein in the step of interpolating the pixel value of the image frame in the intra-field interpolation method and the inter-field interpolation method, when the pixel value of the image frame is interpolated in the inter-field interpolation method, a pixel value of a pixel point corresponding to a target pixel point on an odd field or an even field of the previous image frame, or a pixel value of a pixel point corresponding to the target pixel point on an odd field or an even field of the next image frame is referenced to interpolate the pixel value of the target pixel point.

10. The image processing method as claimed in claim 7, wherein the image frame comprises an odd field and an even field, and in the step of detecting the pixel difference value of the image frame and the previous image frame or the next image frame thereof, the odd field and the even field of the image frame are respectively compared with an odd field and an even field of the previous image frame, or with an odd field and an even field of the next image frame, so as to obtain the pixel difference value.

11. The image processing method as claimed in claim 7, wherein the pixel value of the image frame comprises a grayscale value, a chroma value, or a luminance value.
